(19) United States
(12) Patent Application Publication
(10) Pub. No.: US 2022/0309331 A1
(43) Pub. Date: Sep. 29, 2022

(54) ERROR COMPENSATION IN ANALOG NEURAL NETWORKS

(71) Applicant: AMS INTERNATIONAL AG, Jona (CH)

(72) Inventors: Philipp JANTSCHER, Eindhoven (NL); Florian MAIER, Eindhoven (NL); Benjamin MINIXHOFER, Eindhoven (NL); Ernst HASELSTEINER, Eindhoven (NL); Bernhard PUCHINGER, Eindhoven (NL); Gilbert PROMITZER, Eindhoven (NL)

(21) Appl. No.: 17/618,443

(22) PCT Filed: Jun. 16, 2020
(86) PCT No.: PCT/EP2020/066590

§ 371 Date: Dec. 11, 2021

Related U.S. Application Data
(60) Provisional application No. 62/867,087, filed on Jun. 26, 2019.

(51) Int. Cl. G06N 3/063; G06N 3/04; G06K 9/62

(52) U.S. Cl. CPC G06N 3/0635; G06N 3/04; G06K 9/6201; G06K 9/623; G06K 9/6265

(57) ABSTRACT

A computer-implemented method for compensation of errors due to fabrication tolerance in an analog neural network is described. The method includes: receiving a set of input weights from a trained digital neural network, the digital neural network having the same architecture as the analog neural network and being trained in a digital environment without errors due to fabrication tolerance; loading the set of input weights to the analog neural network; receiving (i) a set of test inputs for error compensation, and (ii) a set of expected outputs that is obtained by processing the set of test inputs using the trained digital neural network; processing the set of test inputs using the analog neural network to generate a set of test outputs; processing the set of test outputs and the set of expected outputs to generate a set of updated weights for the analog neural network; and loading the set of updated weights to the analog neural network.

### BACKGROUND

Neural networks are machine learning models that employ one or more layers of nonlinear units to predict an output for a received input. Some neural networks include an input layer, an output layer, and one or more hidden layers in between. Each layer includes one or more neurons. Each neuron of a particular layer is connected to all neurons of the preceding layer and to all neurons of the subsequent layer. The output of each layer is used as input to the next layer in the network, i.e., the next hidden layer or the output layer. Each layer of the network generates an output from a received input in accordance with current values of a respective set of weights.

### SUMMARY

This specification generally relates to techniques for compensation of errors caused by production-related variations in analog neural network chips by adjusting weights of the analog neural networks implemented in the chips. Production-related variations may include variations in thickness of connections, minor misplacement of elements in different layers of the analog neural networks, which result in different characteristics of chip components such as transistors, resistors and capacitances.

In particular, one innovative aspect of the subject matter described in this specification can be embodied in a method for compensation of errors due to fabrication tolerance in an analog neural network.

The method includes receiving a set of input weights from a trained digital neural network and loading the set of input weights to the analog neural network. The digital neural network has the same architecture as the analog neural network and is trained in a digital environment without errors due to fabrication tolerance.

The method includes receiving (i) a set of test inputs for error compensation, and (ii) a set of expected outputs that is obtained by processing the set of test inputs using the trained digital neural network.

The method includes processing the set of test inputs using the analog neural network to generate a set of test outputs, and processing the set of test outputs and the set of expected outputs to generate a set of updated weights (also referred to as “adjusted weights” throughout this specification) for the analog neural network.

The method includes loading the set of updated weights to the analog neural network.

The foregoing and other embodiments can each optionally include one or more of the following features, alone or in combination.

The above-described method can further include: validating whether the set of updated weights allows the analog neural network to operate within a predetermined accuracy level. In particular, to validate whether the set of updated weights allows the analog neural network to operate within a predetermined accuracy level, the method includes:
receiving a set of validation inputs for validation,
processing the set of validation inputs using the analog neural network to generate a set of validation outputs,
receiving a set of expected validation outputs from the trained digital neural network, wherein the set of expected validation outputs is obtained by processing the set of validation inputs using the trained digital neural network, and
comparing the set of validation outputs and the set of expected validation outputs to determine whether the analog neural network with the updated weights operates within the predetermined accuracy level.

The analog neural networks may include a plurality of physical analog neurons, and the errors may include one or more linear and/or non-linear neuron errors at each of the plurality of physical analog neurons of the analog neural network.

The one or more neuron errors at a physical analog neuron may include at least one of: (i) one or more input offset errors, each input offset error afflicting a respective input of the neuron, (ii) a multiplicative sum error afflicting an input of an activation function at the neuron, or (iii) an activation function offset error afflicting an output of the activation function at the neuron.

In some embodiments, to process the set of test outputs and the set of expected outputs to generate a set of updated weights for the analog neural network, the method includes:
estimating the one or more neuron errors at each physical analog neuron of the analog neural network based on the set of test outputs and the set of expected outputs,
generating an afflicted analog neural network model using the estimated one or more neuron errors at each physical analog neuron of the analog neural network,
initializing a set of weights of the afflicted analog neural network model using the set of input weights, and
training the afflicted analog neural network model using back-propagation to generate the set of updated weights.

In some other embodiments, to process the set of test outputs and the set of expected outputs to generate a set of updated weights for the analog neural network, the method includes:
generating a plurality of sets of simulated errors, each set of simulated errors comprising one or more simulated neuron errors at each physical analog neuron of the analog neural network,
generating a plurality of simulated analog neural network models, each simulated analog neural network model having a respective set of simulated errors,
generating, for each of the simulated analog neural network models, a respective set of trained simulated weights by training the simulated analog neural network model,
for each of the simulated analog neural network models, processing the set of test inputs using the simulated analog neural network model with the respective set of trained simulated weights to generate a respective set of simulated outputs,
selecting, among the sets of simulated outputs generated by the simulated analog neural network models, a particular set of simulated outputs as a best match to the set of test outputs, and
using a particular set of trained simulated weights that results in the particular set of simulated outputs as the set of updated weights for the analog neural network.

To select, among the sets of simulated outputs generated by the simulated analog neural network models, the particular set of simulated outputs as the best match to the set of test outputs, the method includes:
for each of the sets of simulated outputs, computing, based on a distance metric, a respective distance between the set of simulated outputs and the set of test outputs, and
selecting a set of simulated outputs having the shortest distance to the set of test outputs as the particular set of simulated outputs.

In some cases, the distance metric may be a root mean square error (RMSE) metric.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an architecture of an example analog neural network chip that includes an analog neuron network.

FIG. 2 is a block diagram illustrating a general process for (i) compensating errors due to fabrication tolerance in an analog neural network by adjusting weights of the analog neural network and (ii) validating the analog neural network having the adjusted weights.

FIG. 3 illustrates a first example process for adjusting weights of the an analog neural network.

FIG. 4 illustrates a second example process for adjusting weights of an analog neural network.

FIG. 5 shows a third example process for adjusting weights of an analog neural network.

Like reference numbers and designations in the various drawings indicate like elements.

### DETAILED DESCRIPTION

Neural networks are widely used to perform machine learning tasks such as pattern recognition or classification tasks. A neural network generally includes an input layer, an output layer, and one or more hidden layers in between. Each layer includes one or more neurons. Each neuron of a particular layer is connected to all neurons of the preceding layer and to all neurons of the subsequent layer. Each of these connections has a respective weight. The output of each layer is used as input to the next layer in the neural network, i.e., the next hidden layer or the output layer. Each layer of the neural network generates an output from a received input in accordance with current values of a respective set of weights of the layer.

Once input data is provided to the input layer of the neural network, the data is propagated through the whole neural network along the weighted connections. That is, the neural network processes the input data through each of the layers and obtains the output of the output layer as the final output of the neural network. The final output includes outputs generated by neurons of the output layer, where the output of each neuron may represent one of a set of classes (or categories) that the input data could be assigned to. The neuron that has an output with the highest value may signal a result (e.g., a classification result, a regression result, etc.) achieved by the neural network for the given input data.

Traditionally, most implementations of neural networks are software implementations, where the neural networks and their corresponding neurons do not exist physically. Instead, these neural networks are computer programs executed by a digital processor and can be referred to as digital neural networks. Digital neural networks are implemented in a software-based environment, thus they require a general purpose processor such as CPU or GPU to train and execute a neural network model. Such general purpose processor is not available in many applications such as embedded systems or sensors. Further, because computations performed by digital neural networks are digital computations, digital neural networks consume large computational resources and may be slow for high-performing tasks that require real-time or near real-time responses (e.g., robotic hand manipulation tasks, or self-driving car navigation tasks).

Analog neural networks, which are built with analog components that physically exist, can overcome the drawbacks of digital neural networks. Examples of such analog neural networks are described in U.S. Provisional Patent Application 62/834,719, which are incorporated herein by reference in their entirety. The calculations required for the propagation of the data through an analog neural network are at least partially performed as analog computations without the need of a digital processor. Thus, analog neural networks have the following technical advantages over conventional digital neural networks: (i) high parallelism as all neurons can operate at the same time, (ii) fast execution as calculations are simple analog operations, (iii) low power consumption due to the efficient data processing, and (iv) applicable for embedded systems and sensors as no CPU or GPU is required. More particularly, U.S. Provisional Patent Application 62/834,719 describes techniques that allow implementations of a multi-layer analog neural network by repeatedly using a single layer of physical analog neurons. The ability to create an analog neural network that has a single layer of physical analog neurons but can work as a multi-layer neural network provides greater flexibility and scalability compared to conventional methods for implementing analog neural networks.

In order for a digital neural network to learn to perform a machine learning task, a large number of pre-classified training examples are needed to train the digital neural network. Each training example includes a training input and a respective ground-truth output for the training input. Each training input is processed by the neural network to generate a respective output. The output generated by neural network is then compared to the respective ground-truth output of the training input. During training, the values of weights (or parameters) of the neural network are adjusted to such as the outputs generated by the neural network get closer to the ground-truth outputs. More specifically, the weights of the neural network can be adjusted to optimize an objective function computed based on the training data (e.g., to minimize a loss function that represents a discrepancy between an output of the model and a ground-truth output). This training procedure is repeated multiple times for all pre-classified training examples until one or more criteria are satisfied, for example, until the digital neural network has achieved a desired level of accuracy.

To train an analog neural network to determine a set of weights for the analog neural network, a digital neural network that has the same architecture as the analog neural network can be trained in a digital environment (without errors due to fabrication tolerance) using the above-described training procedure. Once the training is complete and a set of digital weights for the digital neural network is determined, the set of digital weights is loaded to the analog neural network. However, when the set of digital weights is transferred from the digital neural network to the analog neural network, i.e., from a simulation to hardware implementation, device-mismatch effects resulting from production-related variations (e.g., fabrication tolerance) in the analog neural network may cause errors during operations by of the analog neural network. These errors may lead to inaccurate outputs of the analog neural networks.

Prior work attempts to solve the above problem by training an analog neural network using a hardware-in-the-loop approach with each single chip. In particular, with this approach, the whole training process is performed by updating weights and inputs of the analog neural network within the chip and reading values of outputs for each of the training steps. However, this approach is time consuming as it needs to be performed for every single chip and is therefore not feasible for mass production.

Another prior approach requires measurements of transfer curves of each individual neuron in an analog neural network in order to adapt the trained analog neural network. However, this approach requires dedicated measurement pins on the final production chip with an analog neural network implemented in it and introduces complexity during production. More specifically, each chip has a certain number of pins to make electrical connections with one or more external systems or devices. A pin can be a voltage supply pin, a data input pin, or a data output pin. The goal is to minimize the number of pins to keep the size of the chip as small as possible. As this approach requires extra measurement pins for measuring chip internal data during production, it increases the size of the chip and therefore is not desirable.

This specification describes error compensation techniques that can solve the problem of time consuming and complex compensation of errors due to fabrication tolerance in analog neural networks. The errors are due to the fact that a fabrication for a semiconductor product does not guarantee exact values for components of the product. For example, while the thickness of the connections can be guaranteed to be in a pre-determined range, e.g., +/−5% of values specified in design data, the exact values for the thickness of connections cannot be guaranteed, and thus errors may be introduced.

In particular, the techniques described herein include processing test inputs using the analog neural network loaded with digital weights to generate test outputs, and processing the test outputs and expected outputs (i.e., outputs generated by the trained digital neural network given test inputs) to generate updated weights for the analog neural network in the chip. Thus, the techniques described herein does not require any measurements of physical properties of chip components or hardware-in-the-loop training. As a result, the described techniques can increase the speed of production testing of analog neural network chips, thereby allowing for mass production of analog neural network chips. In addition, the described techniques can simplify equipment needed for production testing as no analog measurements are needed for error compensation. Further, using the described techniques, the speed of device characterization process during production and adaptation of the trained analog neural network for each chip using retraining techniques can be increased.

Analog Neural Networks

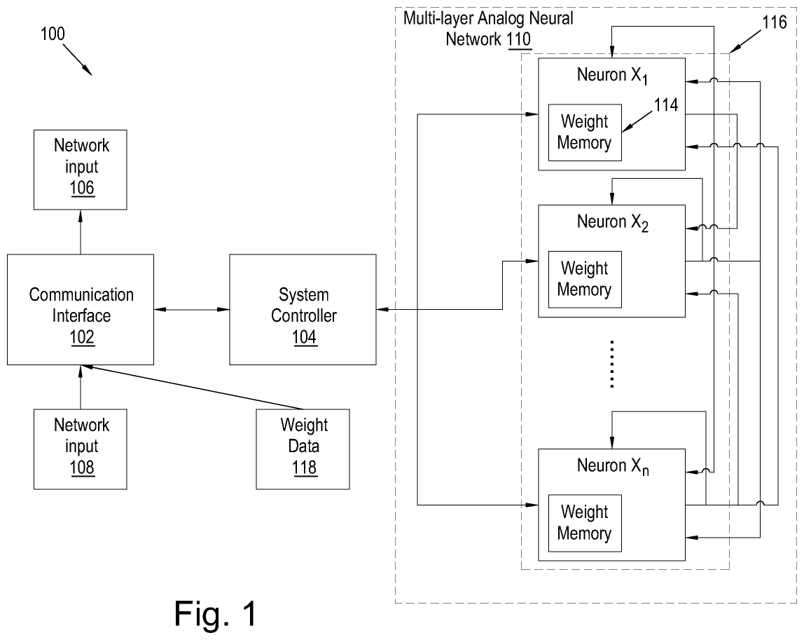

FIG. 1 shows an architecture of an example analog neural network chip 100 that includes an analog neural network. In this example, the analog neural network is a multi-layer analog neuron network implemented by a single layer of physical analog neurons.

The chip 100 includes a multi-layer analog neural network 110 (hereafter referred to as network 110 for simplicity), a communication interface 102, and a system controller 104.

The network 110 has a single layer 116 of physical analog neurons. The single layer 116 of physical analog neurons is re-usable for implementing multiple layers of the network 110. Generally, each of the physical analog neurons is configured to receive a neuron input and to process the neuron input to generate a neuron output. The neuron output is then fed as input to all physical analog neurons of the single layer. Each of the physical analog neurons includes a respective weight memory for storing weights that are used by the neuron to compute neuron outputs given neuron inputs. For example, the analog neuron X₁ has a weight memory 114.

One or more analog neurons in the single layer 116 can act as input neurons that are configured to receive the network input 108 (external input). When the single layer 116 of physical analog neurons is used as the first layer of the network 110, at least one neuron acts as an input neuron, but up to all neurons could work as input neurons. For analog neurons that do not work as input neurons, the input to these analog neurons are set to zero. For layers following the first layer, it can be selected to use zero, one or more analog neurons as input neurons. This is required in order to implement recurrent neural network (RNN) architectures, where the next layer might depend on the current input and the result of the previous layer.

The communication interface 102 connects the multi-layer analog neural network 110 to a computer (or any computing device). The communication interface 102 controls operations of the network 110 (e.g. how many layers shall be calculated) through the system controller 104. The communication interface 102 can be, for example, I2C Bus. The communication interface 102 receives network input 108 from the computer and provides network input 108 to the network 110 through the system controller 104. Once the network 110 processes the network input 108 to generate a network output 106, the communication interface 102 retrieves the network output 106 of the network 110 through the system controller 104. The communication interface 102 then provides the network output 106 to the computer.

The communication interface 102 receives weight data 118 from the computer and transmits the weight data 118 to the system controller 104. The weight data 118 includes, for each neuron of the physical layer 116 of neurons, a respective set of weight vectors with each neuron weight vector corresponding to a respective layer in multiple layers of the network 110. The weight data 118 can be obtained by training a digital neural network that is a simulated version of the network 110 on a digital processor. In some implementations where the network 110 is integrated in a sensor chip, the communication interface 102 can be an internal interface of the sensor chip.

The system controller 104 is a digital circuit configured to receive commands from the computer through the interface 102. The system controllers 104 is configured to keep track and change states of the network 110, e.g., change from a state corresponding to one layer of the network 110 to another state corresponding to the next layer of the network 110. When changing states (also referred to as calculation cycles) of the network 110, the system controller 104 causes a generation of digital signals to control the physical analog neurons of the single layer 116.

More specifically, the system controller 104 is configured to receive the weight data 118 from the interface 102. The system controller 104 loads each set of neuron weight vectors in the weight data 118 to an appropriate analog neuron. Each analog neuron stores its respective set of neuron weight vectors in its weight memory. Each neuron weight vector in the set corresponds to a respective layer of multiple layers of the network 110. That is, if the network 110 hasp layers, then each analog neuron has a respective set of p neuron weight vectors, with each vector being used by the analog neuron for computing a neuron output for the corresponding layer.

As each neuron of the physical layer 116 stores different neuron weight vectors for different layers of the network 110, multiple layers in the network 110 can be implemented using the single physical layer 116. Depending on the currently calculated layer, which is controlled by the system controller 104, each neuron can retrieve, from its respective weight memory, a weight vector that is assigned for the current layer in order to compute a neuron output for a given neuron input for the current layer.

As shown in FIG. 1, the neuron output of each neuron is one of the inputs of all other neurons including the neuron itself. In addition, each neuron has an additional input, which can be directly set by the system controller 104. This additional input is used to provide external inputs (e.g., the network input 108) to neurons.

The weights of each neuron are stored in a weight memory, which is part of the neuron.

In order to perform a full neural network operation with multiple layers, the system controller 104 executes a plurality of calculation cycles with each calculation cycle corresponding to a respective layer of the multiple layers of the network 110. That is, if the network 110 has p layers, the system controller 104 executes p calculation cycles.

At each calculation cycle, each of the neuron outputs generated by the neurons X₁, . . . , Xₙ is fed as input to all analog neurons of the single layer 116 for using in the next calculation cycle. After the last calculation cycle (corresponding to the output layer of the network 110) is performed, the obtained neuron outputs (collectively referred to as the network output 106) are transmitted to the communication interface 102 by the system controller 104. The communication interface 102 then provides the network output 106 to the computer.

While FIG. 1 illustrates an architecture of a multi-layer analog neural network implemented using a single layer of physical analog neurons, the error compensation techniques described in this specification can also apply to other types of analog neural networks.

Calculation of an Analog Neuron Output with and without Device-Mismatch Induced Errors

To compute a neuron output for a given neuron input, each neuron in each layer of an analog neural network may perform calculation based on the following equation (without device-mismatch induced errors):

aⱼ^{l}=ƒ(Σₖwⱼₖ^{l}*aₖ^{l-1}) (Equation 1)

where j denotes the neuron index, l is the index of the layer, and k is the index of the neuron input. aⱼ^{l} is the output produced by a current neuron j of layer l. f is a non-linear activation function. For example, f can be a linear function such as f(x)=x, but the result of the linear function is limited to a maximum of +1 and a minimum of −1. That means, when the value of f(x) is greater than or equal to 1, the value of f(x) is set to +1. When the value of f(x) is less than −1, the value of f(x) is set to −1. Therefore, f is a non-linear function. wⱼₖ^{l}, is the weight between neuron k and current neuron j. aₖ^{l-1} is the input coming from neuron k of previous layer l−1.

During production of analog neural networks, device-mismatch effects resulting from fabrication tolerance may influence the calculation in Equation 1 and therefore errors may be introduced. As a result, the transfer of trained weights (e.g., weight vectors included in weight data 118) from a trained digital neural network to an analog neural network may cause a significant loss of accuracy of the analog neural network.

Below is an example equation for computing a neuron output given a neuron input when errors are introduced in an analog neural network chip. This equation can apply to every neuron of every layer within the analog neural network.

aⱼ^{l}=EF_{ƒ,j}^{l}(ƒ(EF_{sum,j}^{l}(ΣₖE_{w,jk}^{l}(wⱼₖ^{l})EF_{a,jk}^{l}(aⱼₖ^{l-1})))), (2)

where EF( ) is an error function that represents both linear and non-linear error functions and is applied to each term of Equation (1). For example, EF_{a,jk}^{l}(aⱼₖ^{l-1}) represents an input offset error that afflicts the neuron input aⱼₖ^{l-1} of the neuron. EF_{sum,j}^{l}( ) is a multiplicative sum error afflicting the input of the activation function ƒ of the neuron. EF_{ƒ,j}^{l}( ) is an activation function offset error afflicting an output of the activation function of the neuron.

In some implementations, when the errors are linear, Equation (2) can be simplified by using only linear terms. Equation (3) is an example simplified version of Equation (2). As shown in Equation 3, every term in the Equation (2) has a potential offset and a multiplicative error:

aⱼ^{l}=e_{ƒ}_{ₒ}_{,j}^{l}+e_{ƒ}_{ₘ}_{,j}^{l}ƒ(eₛᵤₘ_{ₒ}_{,j}^{l}+eₛᵤₘ_{ₘ}_{,j}^{l}Σₖ(e_{w}_{ₒ}_{,jk}^{l}+e_{w}_{ₘ}_{,jk}^{l}wⱼₖ^{l}(eₐ_{ₒ}_{,jk}^{l}+eₐ_{ₘ}_{,jk}^{l}aⱼₖ^{l-1})), (3)

where o denotes an offset error and m denotes a multiplicative error for each term.

In some implementations, Equation (3) can be further simplified for a specific architecture of the analog neural network chip. For example, when the analog neural network chip has the same architecture as the analog neural network chip 100 of FIG. 1, Equation (3) can be further simplified as follows:

aⱼ^{l}=e_{clip,j}+ƒ((1+e_{sum,j})Σₖwⱼₖ^{l}(aₖ^{l-1}+e_{offs,j})) (4)

where e_{clip,j} represents an offset, which occurs when the activation function shall clip the output, e_{sum,j} represents a multiplicative error, which is applied on the result of the addition, and e_{offs,j} represents another offset which occurs on each input of the neurons, before the input is multiplied with the respective weight.

Compensation of Errors Due to Fabrication Tolerance in an Analog Neural Network

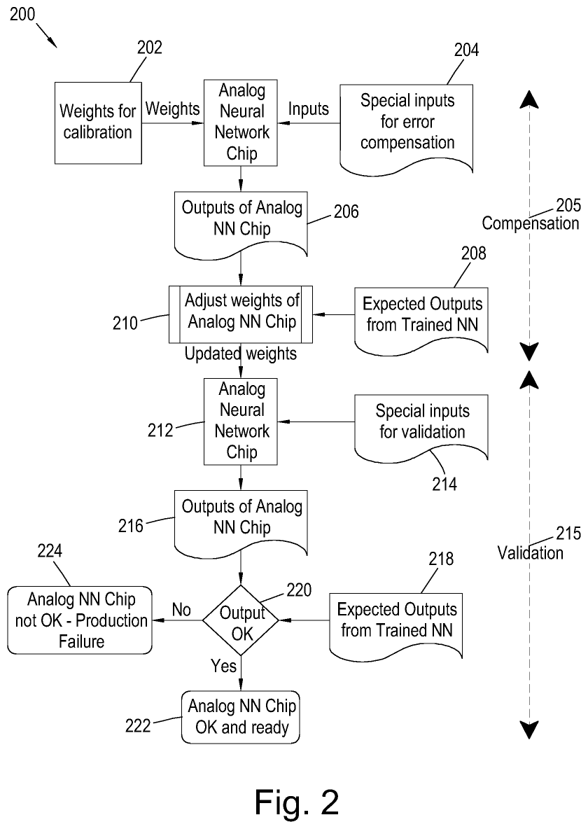

FIG. 2 is a block diagram illustrating a general process 200 for (i) compensating errors due to fabrication tolerance in a physical analog neural network chip by adjusting weights of an analog neural network implemented in the analog neural network chip (compensation phase 205), and/or (ii) validating the analog neural network chip having the analog neural network with the adjusted weights (validation phase 215). In some implementations, the general process 200 may include both the compensation phase 205 and a validation phase 215. In some other implementations, the general process may include only the compensation phase 205. The compensation phase 205 is executed to estimate the adjusted weights that minimize the errors shown in Equation 2.

For convenience, the process 200 will be described as being performed by a system. The system may include software and/or hardware components that are configured in accordance with this specification to perform the process 200.

At the first step 202, the system loads weights of a trained digital neural network into the analog neural network implemented in the analog neural network chip. The digital neural network is a simulated version of the analog neural network (e.g., the digital neural network has the same architecture as the analog neural network) and has been trained on a particular machine learning task that the analog neural network is configured to perform.

Depending on the task, the analog neural network can be configured to receive any kind of digital data input and to generate any kind of score, classification, or regression output based on the input. For example, if the inputs to the analog neural network are images or features that have been extracted from images, the output generated by the analog neural network for a given image may be scores for each of a set of object categories, with each score representing an estimated likelihood that the image contains an image of an object belonging to the category.

Further, the analog neural network can be used to perform other tasks such as estimating a concentration of gas in the air, estimating fat contents of a chocolate based on a measured spectrum, detecting an environment (e.g. an environment where an airplane or a train is operated/located) based on sound measurements.

At step 204, the system receives a predefined set of test inputs for error compensation.

The system processes the set of test inputs using the analog neural network to generate a set of test outputs (step 206). In other words, the system causes the analog neural network to perform a forward execution given the set of test inputs in order to generate a set of test outputs.

The system then receives a set of expected outputs that is obtained by processing the set of test inputs using the trained digital neural network (step 208). In some cases, the system may receive the set of expected outputs before performing step 206.

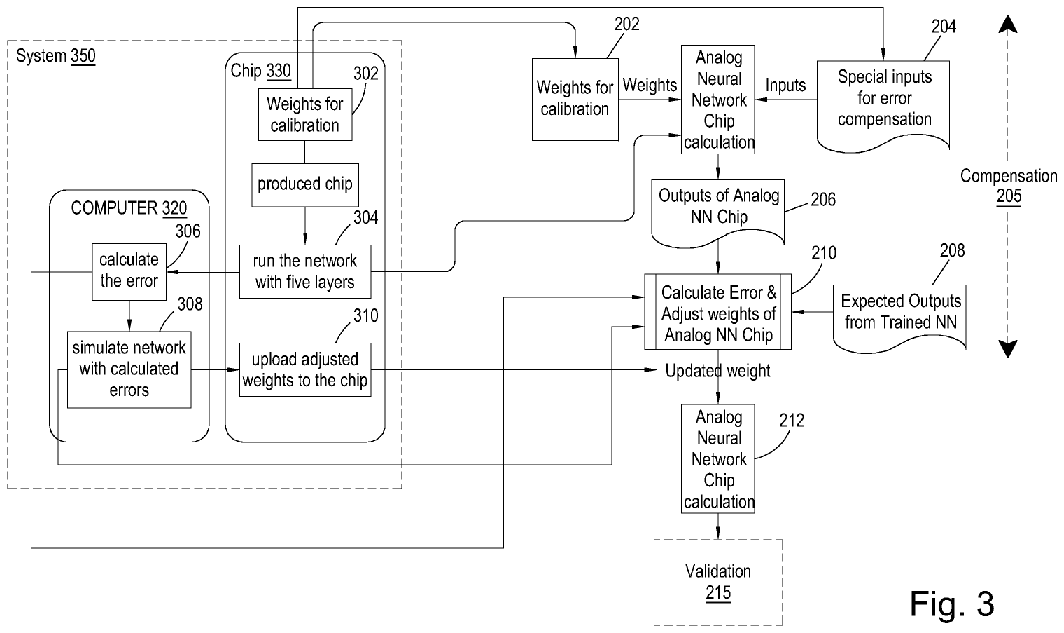

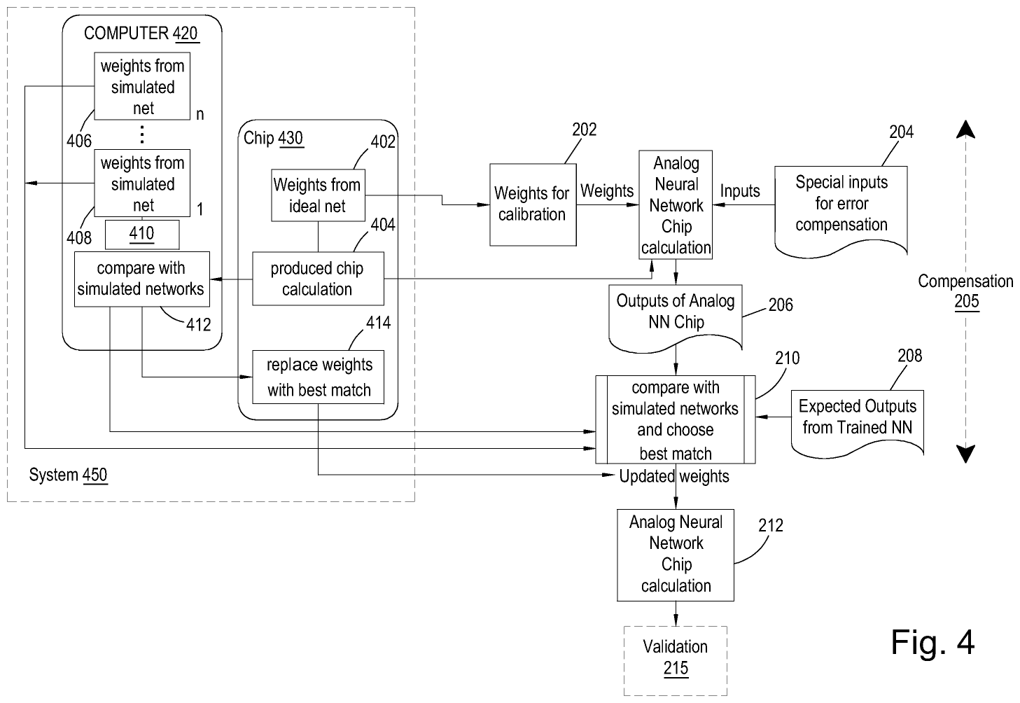

The system processes the set of test outputs and the set of expected outputs to adjust the current weights (i.e., input weights received from the trained digital neural network) of the analog neural network (step 210). After adjusting the current weights, the system obtains a set of updated weights for the analog neural network. The process for adjusting the current weights of the analog neural network is described in more detail below with reference to FIG. 3 and FIG. 4.

The system loads the set of updated weights to the analog neural network (step 212). This step concludes the compensation phase 205.

To execute the validation phases 215, the system receives a predefined set of validation inputs for validation (step 214).

The system then processes the set of validation inputs using the analog neural network (that has the updated weights) to generate a set of validation outputs (step 216). That is, the system causes the analog neural network to perform a forward execution given the set of validation inputs in order to generate a set of validation outputs.

The system then receives a set of expected validation outputs from the trained digital neural network (step 218). The set of expected validation outputs is obtained by processing the set of validation inputs using the trained digital neural network. In some cases, the system may receive the set of expected validation outputs before performing step 216.

The system compares the set of validation outputs and the set of expected validation outputs to determine whether the analog neural network with the updated weights operates within the predetermined accuracy level (step 220). If the analog neural network having the updated weights operates without the predetermined accuracy level, the system determines that the analog neural network chip that implements the analog neural network is acceptable and ready for use (step 222). If the analog neural network having the updated weights does not operate within the predetermined accuracy level (i.e., the fabrication tolerance cannot be compensated), the system determines that the analog neural network chip that implements the analog neural network is not acceptable and cannot be used (step 224). In this case, the chip may be discarded during production test and later destroyed.

FIG. 3 illustrates a first example process for adjusting weights of the an analog neural network. The first example process is executed by a system 350 that includes a computer 320 and an analog neural network chip 330. The process includes steps 302-310, where each step is mapped with a corresponding step in the compensation phase 205 of FIG. 1.

At the first step 302, the system 350 loads a set of input weights for calibration to the analog neural network implemented in the chip 330. The set of input weights is obtained from a trained digital neural network that has the same architecture as the analog neural network and is trained in a digital environment without errors due to fabrication tolerance

The system 350 then causes the chip 330 to execute a forward execution of the analog neural network to process a set of test inputs to generate a set of test outputs (step 304). In the example process A for estimating one or more neural errors described below, 5 analog neural network layers are calculated to determine 5 errors per neuron, and thus the analog neural network executes a forward execution through these five neural network layers.

The system 350 then estimates, using the computer 320, one or more neuron errors at each physical analog neuron of the analog neural network based on the set of test outputs and a set of expected outputs (step 306). The set of expected outputs is obtained by processing the set of test inputs using the trained digital neural network. The process for estimating one or more neuron errors is described in more detail below.

The system 350 generates an afflicted analog neural network model (a simulated model on the computer 320) using the estimated one or more neuron errors at each physical analog neuron of the analog neural network. The system 350 initializes a set of weights of the afflicted analog neural network model using the set of input weights.

The system 350 then trains the afflicted analog neural network model using back-propagation to generate the set of updated weights (step 308).

The system 350 then loads the set of updated weights from the trained afflicted analog neural network model to the analog neural network implemented in the chip 330 (step 310).

After the set of updated weights is loaded to the analog neural network, the system 350 can optionally perform steps in the validation phase 250 as described above with reference to FIG. 1 in order to validate the analog neural network chip 330 having the analog neural network with the updated weights.

Example Process a for Estimating One or More Neuron Errors:

In this example, each neuron is afflicted by three errors as shown below:

aⱼ^{l}=e_{clip,j}+ƒ((1+e_{sum,j})Σₖwⱼₖ^{l}(aₖ^{l-1}+e_{offs,j})), (4)

where error e_{offs} includes two different physical errors. This is caused by two distinct storage elements, which are used in an alternating way. Storage elements are capacitors in the chip used to store charges. The charges represent the input values. There are two stages which are used alternatively: one is used for calculation and the other one is used to store the result of the previous calculation. The two physical errors are denoted with e_{offs_0} and e_{offs_1}. In addition, clipping error e_{clip} is divided into two errors: one error for clipping on an upper limit of the activation function (e.g., +1), denoted as e_{clip_pos}, and one error for clipping on an lower limit of the activation function (e.g., −1), denoted as e_{ctip_neg}.

In total, 5 errors need to be determined for each analog neuron of the analog neural network. This procedure requires 5 analog neural network layers to be calculated to derive 5 equations for determining the 5 errors per neuron. This procedure can be applied to all analog neurons of the analog neural network in parallel. The weights of all connections between different neurons are set to 0, such that neurons don't influence each other.

Inputs for every neuron j for the 5 layer calculations are chosen as follows:

aⱼ⁰=0,aⱼ¹=0,aⱼ²=1,aⱼ³=2,aⱼ⁴=2.

In the first 3 layer calculations, weights of inputs are set to 1, recurrent weights are set to 0, and all other weights are set to 0. As a result, three equations for errors can be constructed as follows:

I: e_{sum,j}*(e_{offs_0,j}+aⱼ⁰)=outⱼ⁰

II: e_{sum,j}*(e_{offs_1,j}+aⱼ¹)=outⱼ¹

III: e_{sum,j}*(e_{offs_0,j}+aⱼ²)=outⱼ²

The system 350 can easily solve the above system of linear equations using computer 320.

The two clipping errors that occur during clipping are calculated by getting the analog neural network to clip at the upper limit of the activation function on the 4^{th} layer calculation (recurrent and input weight are set to 1, and all other weights are set to 0) and at the lower limit at the 5^{th} layer calculation (recurrent and input weight are set to −1, and all other weights are set to zero). The clipping errors can then be calculated by subtracting an ideal clipping value from the actual clipping value as follows:

e_{clip_pos,j}=outⱼ³−xᵤₚₚₑᵣ^{clip}

e_{clip_neg,j}=−(outⱼ⁴−x_{lower}^{clip}),

where xᵤₚₚₑᵣ^{clip} and x_{lower}^{clip} are the ideal upper and lower limit clipping values of the activation function, respectively.

FIG. 4 illustrates a second example process for adjusting weights of an analog neural network. The second example process is executed by a system 450 that includes a computer 420 and an analog neural network chip 430. Each of the second example process is mapped with a corresponding step in the compensation phase 205 of the general process shown in FIG. 1.

The system 450 receives a set of input weights from a trained digital neural network (step 402). The digital neural network has the same architecture as the analog neural network and being trained in a digital environment without errors due to fabrication tolerance. The system 430 loads the set of input weights to the analog neural network, and processes a set of test inputs using the analog neural network to generate a set of test outputs (step 404).

The system 450 generates, using the computer 420, a plurality of sets of simulated errors. For example, the system 450 may generate each set of simulated errors such that the simulated errors are within a predetermined range (for example, +/−10% of values specified in design data), which is expected to occur on a real chip. The system 450 may generate simulated errors using a standard deviation within the predetermined range. Each set of simulated errors includes one or more simulated neuron errors at each physical analog neuron of the analog neural network.

The system 450 generates, using the computer 420, a plurality of simulated analog neural network models. Each simulated analog neural network model has a respective set of simulated errors.

The system 450 generates, using the computer 420, for each of the simulated analog neural network models, a respective set of trained simulated weights (for example, sets of trained simulated weights 402 and 404) by training the simulated analog neural network model.

For each of the simulated analog neural network models, the system 450 processes, using the computer 420, the set of test inputs using the simulated analog neural network model with the respective set of trained simulated weights to generate a respective set of simulated outputs (step 410).

The system 450 selects, among the sets of simulated outputs generated by the simulated analog neural network models, a particular set of simulated outputs as a best match to the set of test outputs (step 412). In particular, for each of the sets of simulated outputs, the system 450 computes, using the computer 420, based on a distance metric, a respective distance between the set of simulated outputs and the set of test outputs. For example, the distance metric can be a root mean square error (RMSE) metric. The system 450 selects a set of simulated outputs having the shortest distance to the set of test outputs as the particular set of simulated outputs.

The system 450 uses a particular set of trained simulated weights that results in the particular set of simulated outputs as the set of updated weights for the analog neural network implemented in the chip 430. The system 450 loads the set of updated weights to the analog neural network in the chip 430 (step 414).

After the set of updated weights is loaded to the analog neural network, the system 450 can optionally perform steps in the validation phase 250 as described above with reference to FIG. 1 in order to validate the analog neural network chip 430 having the analog neural network with the updated weights.

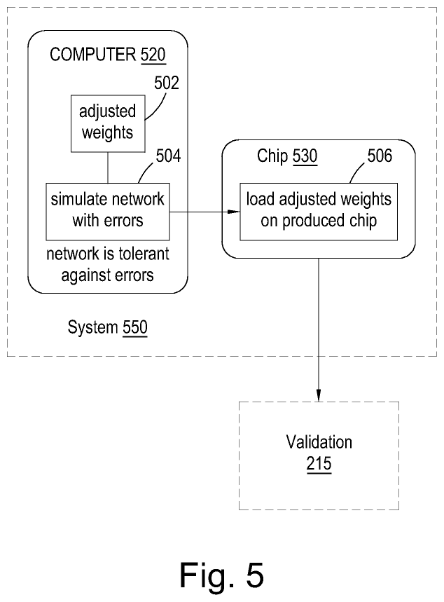

FIG. 5 shows a third example process for adjusting weights of an analog neural network. The third example process is executed by a system 550 that includes a computer 520 and an analog neural network chip 530.

The system 550 is configured to simulate, using the computer 520, a digital neural network with random errors and adjust weights of the digital neural network to minimize the errors shown in Equation 2. As a result, the simulated digital neural network becomes more tolerant of errors. The system 550 then loads the adjusted weights to the analog neural network implemented in the chip 530.

After the adjusted weights is loaded to the analog neural network, the system 450 can optionally perform steps in the validation phase 250 as described above with reference to FIG. 1 in order to validate the analog neural network chip 430 having the analog neural network with the adjusted weights.

This specification uses the term “configured” or “operable” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models (e.g., neural network models such as a digital neural network described in this specification) can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method for compensation of errors due to fabrication tolerance in an analog neural network, the method comprising:
receiving a set of input weights from a trained digital neural network, the digital neural network having the same architecture as the analog neural network and being trained in a digital environment without errors due to fabrication tolerance;
loading the set of input weights to the analog neural network;
receiving (i) a set of test inputs for error compensation, and (ii) a set of expected outputs that is obtained by processing the set of test inputs using the trained digital neural network;
processing the set of test inputs using the analog neural network to generate a set of test outputs;
processing the set of test outputs and the set of expected outputs to generate a set of updated weights for the analog neural network; and
loading the set of updated weights to the analog neural network.

2. The method of claim 1, further comprising validating whether the set of updated weights allows the analog neural network to operate within a predetermined accuracy level.

3. The method of claim 2, wherein validating whether the set of updated weights allows the analog neural network to operate within a predetermined accuracy level comprises: receiving a set of validation inputs for validation,
processing the set of validation inputs using the analog neural network to generate a set of validation outputs,
receiving a set of expected validation outputs from the trained digital neural network, wherein the set of expected validation outputs is obtained by processing the set of validation inputs using the trained digital neural network, and comparing the set of validation outputs and the set of expected validation outputs to determine whether the analog neural network with the updated weights operates within the predetermined accuracy level.

4. The method of claim 1, wherein the analog neural network comprises a plurality of physical analog neurons, and wherein the errors comprise one or more neuron errors at each of the plurality of physical analog neurons of the analog neural network.

5. The method of claim 4, wherein the one or more neuron errors at a physical analog neuron comprise at least one of: (i) one or more input offset errors, each input offset error afflicting a respective input of the neuron, (ii) a multiplicative sum error afflicting an input of an activation function at the neuron, or (iii) an activation function offset error afflicting an output of the activation function at the neuron.

6. The method of claim 4, wherein processing the set of test outputs and the set of expected outputs to generate a set of updated weights for the analog neural network comprises:
estimating the one or more neuron errors at each physical analog neuron of the analog neural network based on the set of test outputs and the set of expected outputs,
generating an afflicted analog neural network model using the estimated one or more neuron errors at each physical analog neuron of the analog neural network,
initializing a set of weights of the afflicted analog neural network model using the set of input weights,
training the afflicted analog neural network model using back-propagation to generate the set of updated weights.

7. The method of claim 4, wherein processing the set of test outputs and the set of expected outputs to generate a set of updated weights for the analog neural network comprises:
generating a plurality of sets of simulated errors, each set of simulated errors comprising one or more simulated neuron errors at each physical analog neuron of the analog neural network,
generating a plurality of simulated analog neural network models, each simulated analog neural network model having a respective set of simulated errors,
generating, for each of the simulated analog neural network models, a respective set of trained simulated weights by training the simulated analog neural network model,
for each of the simulated analog neural network models, processing the set of test inputs using the simulated analog neural network model with the respective set of trained simulated weights to generate a respective set of simulated outputs,
selecting, among the sets of simulated outputs generated by the simulated analog neural network models, a particular set of simulated outputs as a best match to the set of test outputs, and
using a particular set of trained simulated weights that results in the particular set of simulated outputs as the set of updated weights for the analog neural network.

8. The method of claim 7, wherein selecting, among the sets of simulated outputs generated by the simulated analog neural network models, the particular set of simulated outputs as the best match to the set of test outputs comprises:
for each of the sets of simulated outputs, computing, based on a distance metric, a respective distance between the set of simulated outputs and the set of test outputs, and selecting a set of simulated outputs having the shortest distance to the set of test outputs as the particular set of simulated outputs.

9. The method of claim 8, wherein the distance metric is a root mean square error (RMSE) metric.

10. One or more non-transitory computer storage media storing instructions that, when executed by one or more processors, cause the one or more processors to perform operations comprising:
receiving a set of input weights from a trained digital neural network, the digital neural network having the same architecture as the analog neural network and being trained in a digital environment without errors due to fabrication tolerance;
loading the set of input weights to the analog neural network;
receiving (i) a set of test inputs for error compensation, and (ii) a set of expected outputs that is obtained by processing the set of test inputs using the trained digital neural network;
processing the set of test inputs using the analog neural network to generate a set of test outputs;
processing the set of test outputs and the set of expected outputs to generate a set of updated weights for the analog neural network; and
loading the set of updated weights to the analog neural network.

11. The one or more non-transitory computer storage media of claim 10, wherein the operations further comprise: validating whether the set of updated weights allows the analog neural network to operate within a predetermined accuracy level.

12. The one or more non-transitory computer storage media of claim 11, wherein validating whether the set of updated weights allows the analog neural network to operate within a predetermined accuracy level comprises:
receiving a set of validation inputs for validation,
processing the set of validation inputs using the analog neural network to generate a set of validation outputs,
receiving a set of expected validation outputs from the trained digital neural network, wherein the set of expected validation outputs is obtained by processing the set of validation inputs using the trained digital neural network, and
comparing the set of validation outputs and the set of expected validation outputs to determine whether the analog neural network with the updated weights operates within the predetermined accuracy level.

13. The one or more non-transitory computer storage media of claim 10, wherein the analog neural network comprises a plurality of physical analog neurons, and wherein the errors comprise one or more neuron errors at each of the plurality of physical analog neurons of the analog neural network.

14. The one or more non-transitory computer storage media of claim 13, wherein the one or more neuron errors at a physical analog neuron comprise at least one of: (i) one or more input offset errors, each input offset error afflicting a respective input of the neuron, (ii) a multiplicative sum error afflicting an input of an activation function at the neuron, or (iii) an activation function offset error afflicting an output of the activation function at the neuron.

15. The one or more non-transitory computer storage media of claim 13, wherein processing the set of test outputs and the set of expected outputs to generate a set of updated weights for the analog neural network comprises:
estimating the one or more neuron errors at each physical analog neuron of the analog neural network based on the set of test outputs and the set of expected outputs,
generating an afflicted analog neural network model using the estimated one or more neuron errors at each physical analog neuron of the analog neural network,
initializing a set of weights of the afflicted analog neural network model using the set of input weights, training the afflicted analog neural network model using back-propagation to generate the set of updated weights.

16. The one or more non-transitory computer storage media of claim 13, wherein processing the set of test outputs and the set of expected outputs to generate a set of updated weights for the analog neural network comprises:
generating a plurality of sets of simulated errors, each set of simulated errors comprising one or more simulated neuron errors at each physical analog neuron of the analog neural network,
generating a plurality of simulated analog neural network models, each simulated analog neural network model having a respective set of simulated errors,
generating, for each of the simulated analog neural network models, a respective set of trained simulated weights by training the simulated analog neural network model,
for each of the simulated analog neural network models, processing the set of test inputs using the simulated analog neural network model with the respective set of trained simulated weights to generate a respective set of simulated outputs,
selecting, among the sets of simulated outputs generated by the simulated analog neural network models, a particular set of simulated outputs as a best match to the set of test outputs, and
using a particular set of trained simulated weights that results in the particular set of simulated outputs as the set of updated weights for the analog neural network.

17. The one or more non-transitory computer storage media of claim 16, wherein selecting, among the sets of simulated outputs generated by the simulated analog neural network models, the particular set of simulated outputs as the best match to the set of test outputs comprises:
for each of the sets of simulated outputs, computing, based on a distance metric, a respective distance between the set of simulated outputs and the set of test outputs, and
selecting a set of simulated outputs having the shortest distance to the set of test outputs as the particular set of simulated outputs.

18. The one or more non-transitory computer storage media of claim 17, wherein the distance metric is a root mean square error (RMSE) metric.

19. A system comprising one or more processors and one or more non-transitory storage media storing instructions that, when executed by the one or more processors, cause the one or more processors to perform operations comprising:
receiving a set of input weights from a trained digital neural network, the digital neural network having the same architecture as the analog neural network and being trained in a digital environment without errors due to fabrication tolerance;
loading the set of input weights to the analog neural network;
receiving (i) a set of test inputs for error compensation, and (ii) a set of expected outputs that is obtained by processing the set of test inputs using the trained digital neural network;
processing the set of test inputs using the analog neural network to generate a set of test outputs;
processing the set of test outputs and the set of expected outputs to generate a set of updated weights for the analog neural network; and
loading the set of updated weights to the analog neural network.

20. The system of claim 19, wherein the operations further comprise: validating whether the set of updated weights allows the analog neural network to operate within a predetermined accuracy level.
